(19) United States
(12) Patent Application Publication
(10) Pub. No.: US 2017/0147215 A1
(43) Pub. Date: May 25, 2017

(54) WRITING DATA IN A SHINGLED MAGNETIC RECORDING STORAGE MEDIUM

(71) Applicant: International Business Machines Corporation, Armonk, NY (US)

(72) Inventors: Peter Cronauer, Budenheim (DE); Michael Diederich, Mainz (DE); Thorsten Muehge, Budenheim (DE); Erik Rueger, Ockenheim (DE)

(21) Appl. No.: 14/946,804

(22) Filed: Nov. 20, 2015

(51) Int. Cl. G06F 3/06; G06F 12/08

(52) U.S. Cl. CPC G06F 3/064; G06F 3/0604; G06F 3/0643; G06F 3/0676; G06F 12/0804; G06F 2212/202; G06F 2212/60

(57) ABSTRACT

A plurality of logically sequential data blocks of a file to write to a shingled magnetic disk are received. The first data block of the plurality of logically sequential data blocks to a first physical data block of a data track, wherein the first physical data block is part of a sub-band of radially adjacent physical data blocks in a shingled direction, is written. The remaining data blocks of the plurality of logically sequential data blocks to radially adjacent physical data blocks in the sub-band in the shingled direction, beginning with a physical data block radially adjacent to the first physical data block, are written.

### BACKGROUND OF THE INVENTION

The present invention relates generally to the field of shingled magnetic recording (SMR) storage media, and more particularly writing data to SMR storage media.

### SUMMARY

Embodiments of the present invention disclose a method, a computer system, and computer program products. A plurality of logically sequential data blocks of a file to write to a shingled magnetic disk are received. The first data block of the plurality of logically sequential data blocks to a first physical data block of a data track, wherein the first physical data block is part of a sub-band of radially adjacent physical data blocks in a shingled direction, is written. The remaining data blocks of the plurality of logically sequential data blocks to radially adjacent physical data blocks in the sub-band in the shingled direction, beginning with a physical data block radially adjacent to the first physical data block, are written.

### BRIEF DESCRIPTION OF THE DRAWINGS

FIGS. 1A and 1B are block diagrams of a shingled magnetic disk environment, in accordance with an embodiment of the present invention;

FIGS. 2A-2C are block diagrams depicting write and update operations in a shingled magnetic disk, in accordance with an embodiment of the present invention;

FIGS. 3A-3C are block diagrams depicting typical write and update operations in a shingled magnetic disk;

FIG. 4 is a flowchart illustrating operational steps for a write operation in a shingled magnetic disk, in accordance with an embodiment of the present invention;

FIG. 5 is a flowchart illustrating operational steps for a read operation in a shingled magnetic disk, in accordance with an embodiment of the present invention;

FIG. 6 is a flowchart illustrating operational steps for an update operation in a shingled magnetic disk, in accordance with an embodiment of the present invention; and

FIG. 7 is a block diagram of internal and external components of the computer systems of FIG. 1, in accordance with an embodiment of the present invention.

### DETAILED DESCRIPTION

SMR storage media includes at least one magnetic medium, for example, a disk, and a read/write head that can write data to the magnetic medium as data tracks. A set of data tracks can be identified as a data band and each data track is written in a concentric circle onto a magnetic medium. Data bands can be physically separated from one another by an inter-band gap. Each data track includes a plurality of data blocks, where a data block is a contiguous set of bits or bytes that forms an identifiable unit of data, and can be accessed as a magnetic medium moves past a read/write head. A logical location of each data block of a data track can be identified by disk logic of a disk controller. A set of radially adjacent data blocks in data tracks that are a part of a same data band can be referred to as a sub-band.

Shingled tracks are written to a shingled magnetic disk of an SMR storage medium by a specialized SMR read/write head. A SMR write head has a radial dimension that is larger than a shingled track. In some instances, the size of SMR write head causes a new write command for a shingled track to write data for an entire data band of the shingled track. For example, a rewrite of one single data block on a first shingled track results in writing to all overlapping data blocks which are within the data band. As shingled tracks are written, a subsequent shingled track in a set of shingled tracks is written at, for example, an inner radial position and partially overlaps a previous track in the radial direction. Stated differently, a first shingled track and a second shingled track may be written to a shingled magnetic disk of a SMR storage medium, such that a portion of the first shingled track is overwritten, or “shingled”, by the second shingled track. The portion of the first shingled track that is not overwritten is a data track.

Typically, writing data to an SMR storage medium involves writing data blocks to a shingled track. For example, a data band may contain three shingled tracks, where each of the three shingled tracks contain three data blocks. An update operation may be executed on the three data blocks written to the first of the three shingled tracks. To update the three data blocks written to the first shingled track, a disk controller may update and/or rewrite three data blocks written to each of the second and the third shingled tracks. Accordingly, an update operation performed on the three data blocks written to the first shingled track involves updating and/or rewriting six additional data blocks, where the six additional data blocks include each data block that is radially adjacent in a shingled direction one of the three data blocks of the first shingled track, and of a same sub-band as one of the three data blocks of the first shingled track. The six additional data blocks may require to be updated and/or rewritten in response to an update operation executed on the three data blocks of the first shingled track, because three of the six additional data blocks of the second shingled track are radially adjacent to three of the six additional data blocks of the first shingled track, and three of the six additional data blocks of the third shingled track are radially adjacent to the three of the six additional data blocks of the second shingled track. In general, an update and/or rewrite operation of a single data block on a sub-band results in updating and/or rewriting data blocks that are radially adjacent in a shingled direction to the single data block and that are in the same sub-band of the single data block.

Embodiments of the present invention provide systems, methods, and computer program products for writing data in SMR storage medium. Embodiments of the present invention can be implemented in operations involving data blocks that are written to shingled tracks of SMR storage medium. For illustrative purposes, various examples and details are set forth to provide an understanding of the present disclosure.

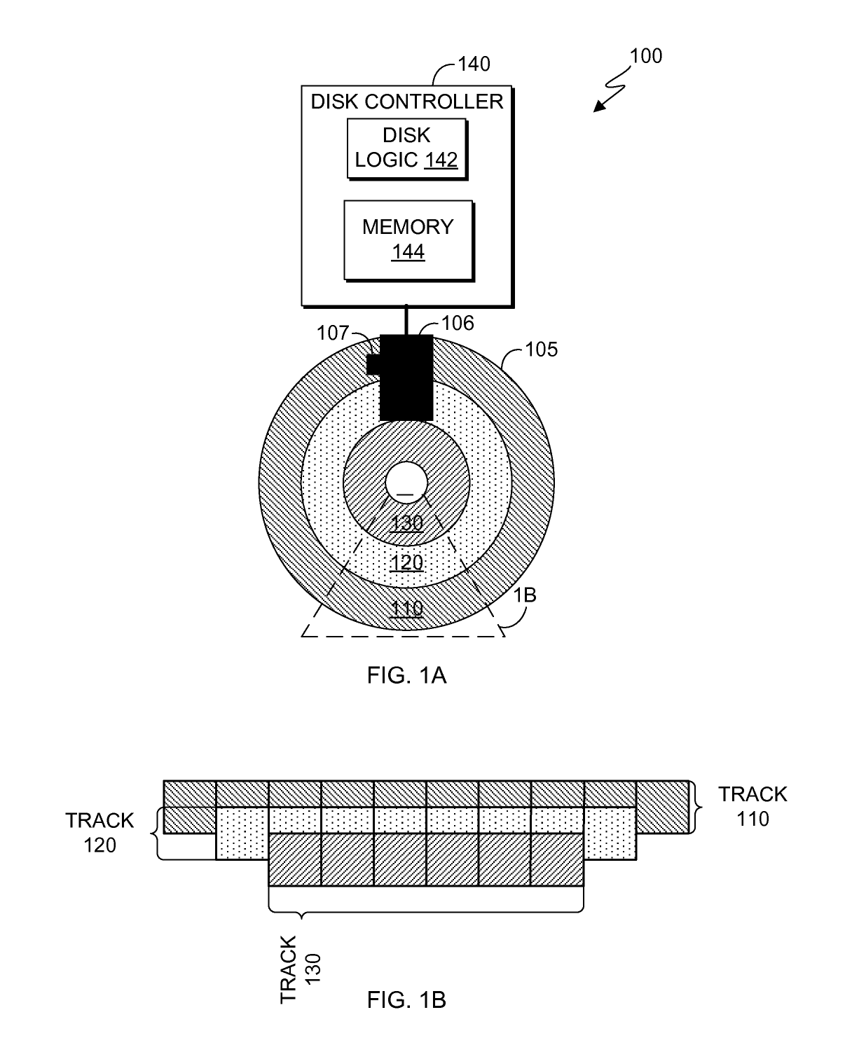

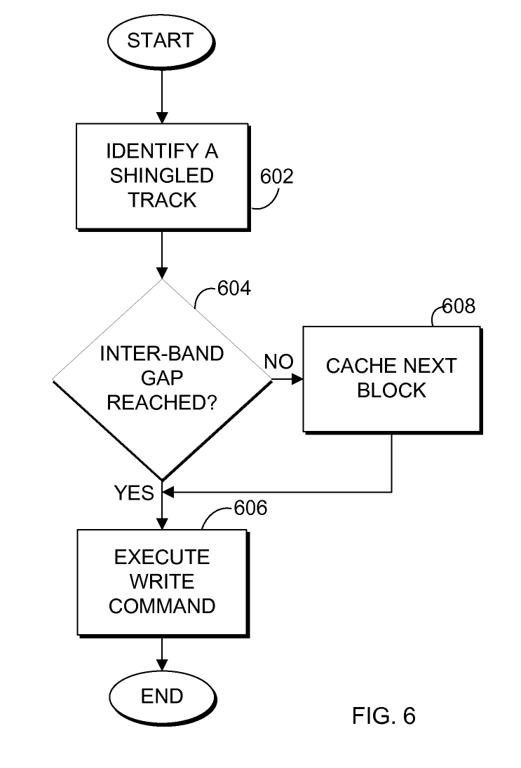

FIGS. 1A and 1B are block diagrams of an SMR storage medium environment 100, in accordance with an embodiment of the present invention. SMR storage medium environment 100 includes shingled magnetic disk 105, write head 106, read head 107, and disk controller 140. SMR storage medium environment 100 can include more than one shingled magnetic disks 105. Shingled magnetic disk 105 is a non-volatile magnetic storage medium that stores data for a computer system, such as described in greater detail with regard to FIG. 6. Write head 106 has a radial dimension that is larger than one of shingled tracks 110-130, such that when a write command is executed on shingled track 110, data is also written to shingled track 120 and shingled track 130, as described in greater detail below. Read head 107 typically is much smaller relative to write head 106.

Shingled tracks 110-130 represent circular divisions of data, or data tracks, written to shingled magnetic disk 105. Each of shingled tracks 110-130 is organized, or formatted, as a plurality of physical data blocks that contain a contiguous set of bits or bytes. In this embodiment, shingled track 110 is written, in a shape of a concentric circle, to shingled magnetic disk 105 with a larger radius compared to shingled track 120 and shingled track 130. Shingled tracks 110-130 are written to shingled magnetic disk 105 in a shingled manner, with shingled track 110 written first, shingled track 120 written second, and shingled track 130 written last. FIG. 1B, illustrates a data band that includes shingled tracks 110-130. In this embodiment, shingled track 110 and shingled track 120 may be written to a shingled magnetic disk 105, such that a portion of shingled track 110 is overwritten, or “shingled”, by shingled track 120. Shingled track 120 is radially adjacent to shingled track 110 and is written to shingled magnetic disk 105 in a shingled direction. A next shingled track from shingled track 120 is shingled track 130, which is also radially adjacent to shingled track 120 in the shingled direction.

Disk controller 140 represents logic that enables a central processing unit (CPU) of a computer system to interact with data on shingled magnetic disk 105. Disk controller 140 can process signals from a computer system, and control the reading and/or writing of data by a read/write head. In one embodiment, subsequent to executing a write command, the read/write head controlled by disk controller 140 can execute a read command to verify that the write command was executed. Write, read, update, and rewrite operations may involve a plurality of read and/or write commands that are received by disk controller 140.

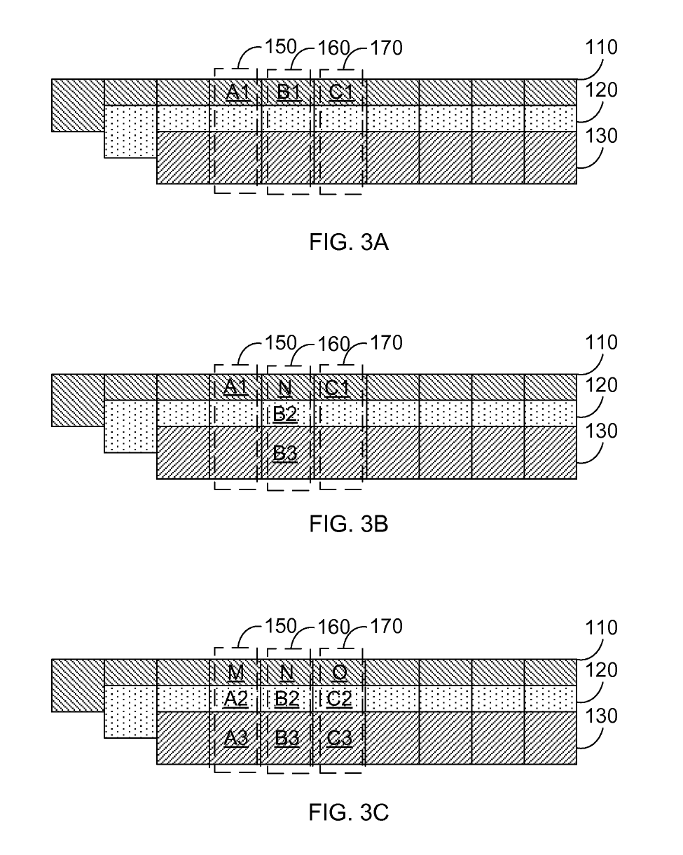

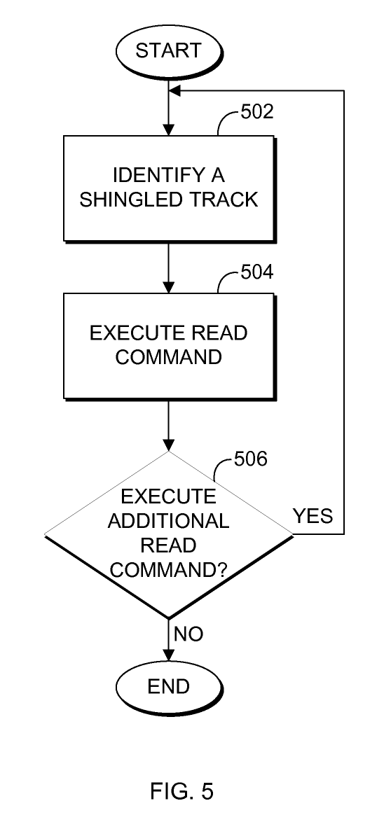

Disk logic 142 represents logic for managing write, read, update, and rewrite operations by issuing read and/or write commands to disk controller 140. For example, disk logic 142 can issue a number of write commands to complete a write operation for data of a particular file, as described in greater detail with regard to FIG. 3. Disk logic 142 may also identify a location of data associated with a particular file for an update operation, as described in greater detail with regard to FIG. 5. Disk logic 142 can identify a location of a data block to read from and/or write to. For example, in FIG. 1B, disk logic 142 can identify a data block on a first shingled track 110 for a write command, and identify a data block of a same sub-band on shingled track 120 for a subsequent write command.

Memory 144 represents a memory component that can include a memory buffer component and/or cache component used to buffer data during read and write operations. For example, disk logic 142 can retrieve data stored in memory 144 to write data to shingled magnetic disk 105. In another example, memory 144 may contain data received from a computer system that is a part of SMR storage medium environment 100 and is cached during an update operation and/or a rewrite operation.

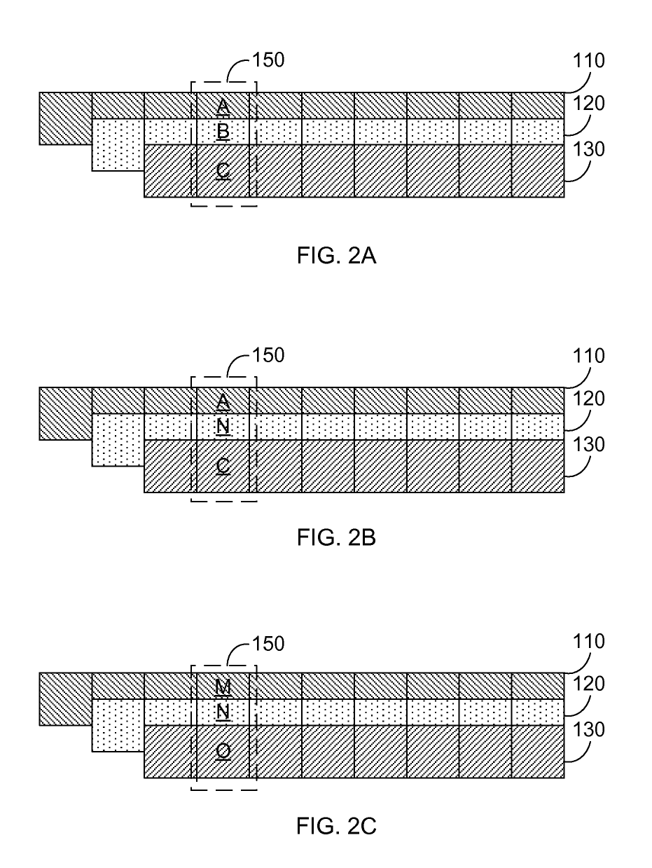

FIGS. 2A-2C are block diagrams depicting write and update operations in shingled magnetic disk 105, in accordance with an embodiment of the present invention. Disk logic 142 identifies a data block and a shingled track on which to execute a write and/or read command. In this embodiment, disk logic 142 executes write commands to shingled tracks 110-130, such that data is written to physical data blocks that are a part of a same sub-band. Disk logic 142 may write data to physical data blocks in shingled tracks 110-130 that are part of a same sub-band until a data block gap, such as an inter-band gap, or a data block that does not need updating, for example, a deleted file, is reached.

FIG. 2A is a block diagram that depicts a write operation. Data for a particular file can be stored on three shingled tracks 110-130 and may comprise three data blocks, block A, block B, and block C. Disk logic 142 can write block A, block B, and block C during a write operation. For example, during a write operation, disk logic 142 executes a first write command by writing block A to a first shingled track 110. At a later time, disk logic 142 executes a second write command by writing block B to a next shingled track 120, and subsequently, disk logic 142 executes a third write command by writing block C to a next shingled track 130. In this write operation, each write command is executed to sub-band 150. During this write operation, disk logic 142 identifies one of shingled tracks 110-130 to write to. Disk logic 142 may identify one of shingled tracks 110-130 that is radially adjacent in a shingled direction to one of shingled tracks 110-130 associated with a most recently executed write command. For example, disk logic 142 may identify shingled track 130 as the next shingled track to write to, responsive to determining that shingled track 120 includes a data block in a same sub-band for a most recently executed write command. In one embodiment, an inter-band gap has been reached once block C is written to shingled track 130. When an inter-band gap has been reached, disk logic 142 may identify one of shingled tracks 110-130 to write to that is a part of a different sub-band or an entirely different band.

FIG. 2B is a block diagram that depicts an update operation. An update operation is performed by disk logic 142 on block B, such that block C is read from shingled track 130, cached to memory 144, and then a new data block, data block N is written. Subsequently to writing block N, disk logic 142 rewrites block C that was cached to memory 144. An update or rewrite operation performed on one of blocks A-C in sub-band 150 can result in additional update and/or rewrite operations for blocks A-C that are radially adjacent in a shingled direction to the updated one of blocks A-C in sub-band 150. For example, an update operation for block B can result in an update or a rewrite operation for block C written to shingled track 130. Accordingly, an update operation for block B involving shingled magnetic disk 105 written in a manner as described in FIG. 2A, results in updating and/or rewriting two data blocks, whereas a typical update operation for block B involving shingled magnetic disk 105 written in a manner as described in FIG. 3A, may result in updating and/or rewriting three data blocks, as described in greater detail with regard to FIG. 3B.

FIG. 2C is a block diagram that depicts another update operation. In this embodiment, an update operation is performed by disk logic 142 on blocks A-C, such that blocks A-C are updated on shingled track 110, shingled track 120, and shingled track 130 as block M, block N, and block 0, respectively. In one embodiment, a rewrite operation may be performed on blocks A-C, such that blocks A-C are read from shingled tracks 110-130, cached to memory 144, and rewritten as block A-C. Accordingly, an update operation for blocks A-C involving shingled magnetic disk 105 written in a manner as described in FIG. 2A, results in updating and/or rewriting three data blocks, whereas a typical update operation for block A-C involving shingled magnetic disk 105 written in a manner as described in FIG. 3A, may result in updating and/or rewriting nine data blocks, as described in greater detail with regard to FIG. 3C.

FIG. 3A is a block diagram that depicts a typical write operation. Data for a particular file can be stored on shingled track 110 and may comprise three data blocks, block A1, block B1, and block C1, such that block A1 is written to sub-band 150, block B1 is written to sub-band 160 that is circumferentially adjacent to block A1, and block C1 is written to sub-band 170 that is circumferentially adjacent to block B1.

FIG. 3B is a block diagram that depicts a typical update operation for block B1. In this typical update operation, block B1 is updated with a new data block, block N. As previously described, a SMR read/write head has a radial dimension that is larger than a shingled track. As shingled tracks are written, a subsequent shingled track in a set of shingled tracks is written at, for example, an inner radial position and partially overlaps a previous track in the radial direction. Accordingly, block B2 and block B3 are rewritten to shingled track 120 and shingled track 130 respectively.

FIG. 3C is a block diagram that depicts another typical update operation for block A1, block B1, and block C1. In this typical update operation, block A1, block B1, and block C2 are updated with new data blocks, block M, block N, and block C, respectively. As previously described, each data block that is radially adjacent in a shingled direction and of a same sub-band as a block that is updated in a typical update operation, is rewritten or updated. Accordingly, the typical SMR update operation for block A1, block B1, and block C1 involves updating or rewriting nine blocks, including block A1, block B1, and block C1, in addition to each block of a same sub-band of block A1, such as block A2 and block A3 on sub-band 150, each block of a same sub-band of block B1, such as block B2 and block B3 on sub-band 160, and each block of a same sub-band of block C1, such as block C2 and block C3 on sub-band 170.

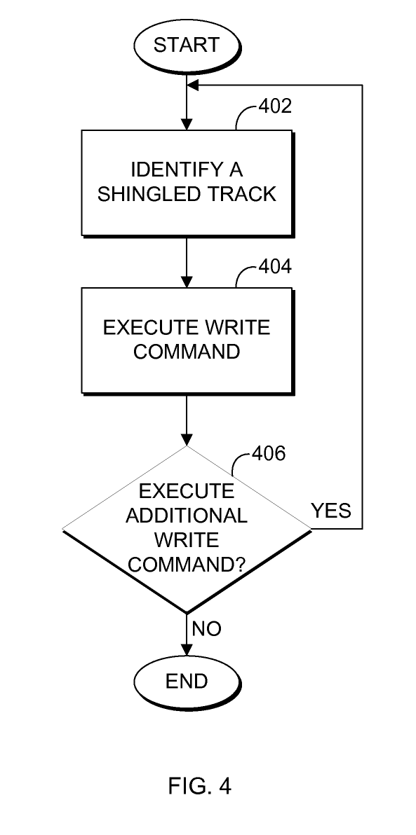

FIG. 4 is a flowchart illustrating operational steps performed by disk logic 142 for a write operation to shingled magnetic disk 105, in accordance with an embodiment of the present invention. In this embodiment, disk controller 140 implements disk logic 142 to write shingled tracks 110-130 to shingled magnetic disk 105. A write operation may involve disk logic 142 executing one or more write commands.

At a start of a write operation, disk logic 142 identifies a first of shingled tracks 110-130 for a first write command (step 402). Identifying the first of shingled tracks 110-130 for the first write command can be based on a number, location, and/or arrangement of available physical data blocks on shingled magnetic disk 105. Accordingly, once disk logic 142 identifies the first of shingled tracks 110-130 for the first write command, disk logic 142 executes the write command and data is written to the first of shingled tracks 110-130 (step 404).

After data is written to the first of shingled tracks 110-130, disk logic 142 determines whether to issue an additional write command (decision 406). In one embodiment, an additional write command may be necessary if a first write command did not complete the write operation. For example, a write operation may involve issuing and executing two write commands to data blocks of a same sub-band. In this example, a first of the two data blocks is successfully written in step 304 to a first of shingled tracks 110-130, and disk logic 142 determines to issue an additional write command to complete the write operation.

If disk logic 142 determines to execute an additional write command (“yes” branch, decision 406), then disk logic 142 identifies a next of shingled tracks 110-130 for the additional write command (step 402). In this embodiment, a next of shingled tracks 110-130 for the additional write command is identified as one of shingled tracks 110-130 that is radially adjacent in a shingled direction to the first of shingled tracks 110-130 associated with the most recently executed write command. In certain embodiments, such as when an inter-band gap is reached, a different sub-band may be identified as the sub-band associated with an execution of the additional write command. If disk logic 142 determines not to execute another write command (“no” branch, decision 406), then disk logic 142 terminates operational steps as described herein.

FIG. 5 is a flowchart illustrating operational steps for a read operation from shingled magnetic disk 105, in accordance with an embodiment of the present invention. In this embodiment, disk controller 140 implements disk logic 142 to perform the read operation from shingled magnetic disk 105. A read operation may involve disk logic 142 executing one or more read commands.

At a start of a read operation, disk logic 142 identifies a first of shingled tracks 110-130 for a first read command (step 502). Once disk logic 142 identifies the first of shingled tracks 110-130 for the first read command of a read operation, disk logic 142 executes a read command, such that the data is read from the first of shingled tracks 110-130 (step 504).

After data is read from the first of shingled tracks 110-130, disk logic 142 determines whether to execute an additional read command (decision 506). In one embodiment, an additional read command may be necessary if a first read command did not complete the read operation. For example, a read operation may involve executing two read commands on two data blocks of a same sub-band. In this example, a first of the two data blocks is successfully read in step 504 from the first of shingled tracks 110-130, and disk logic 142 executes an additional read command to complete the read operation.

If disk logic 142 determines to execute an additional read command (“yes” branch, decision 506), then disk logic 142 identifies a next of shingled tracks 110-130 for the additional read command (step 502). In this embodiment, a next of shingled tracks 110-130 for the additional read command is identified as one of shingled tracks 110-130 that is radially adjacent in a shingled direction to the first of shingled tracks 110-130 associated with the most recently executed read command. In certain embodiments, such as when an inter-band gap is reached, a different sub-band may be identified as the sub-band to be associated with the execution of the new read command. If disk logic 142 determines not to issue another read command (“no” branch, decision 506), then disk logic 142 terminates operational steps as described herein.

FIG. 6 is a flowchart illustrating operational steps for an update operation on shingled magnetic disk 105, in accordance with an embodiment of the present invention. In this embodiment, disk controller 140 implements disk logic 142 to perform the update operation on shingled magnetic disk 105. An update or rewrite operation can be performed using similar operational steps, as described herein, and may involve executing one or more read and write commands.

At the start of an update operation, disk logic 142 identifies one of shingled tracks 110-130 that contains a data block for an update operation (step 602). In one embodiment, disk logic 142 may determine a total number of data blocks to be updated, and a location of each of the total number of physical data blocks on shingled magnetic disk 105. After disk logic 142 identifies the one of shingled tracks 110-130, disk logic 142 determines whether an inter-band gap has been reached (decision 604). For example, the identified one of shingled tracks 110-130 containing a data block for an update can be block C of shingled track 130 in FIG. 2A. In this example, disk logic 142 determines that the inter-band gap has been reached. In another embodiment, disk logic 142 can determine if a data block gap has is radially adjacent in a shingled direction to the identified one of shingled tracks 110-130.

If disk logic 142 determines that an inter-band gap has been reached (“yes” branch, decision 604), then disk logic 142 executes a write command, such that updated data associated with the executed write command is written to the identified one of shingled tracks 110-130 (step 606). If disk logic 142 determines that an inter-band gap has not been reached (“no” branch, decision 606), then disk logic 142 caches a next data block of a same sub-band (step 608). In this embodiment, the next data block of the same sub-band is a data block that is radially adjacent in a shingled direction to a data block requiring an update contained in the identified one of shingled tracks 110-130. For example, to cache a next data block in a same sub-band, such as block B in sub-band 150 of FIG. 2A, disk logic 142 may issue a read command to read the next data block in the same-sub band, such as block C in sub-band 150 of FIG. 2A, and store the next data block to memory 144. After the next data block is cached, disk logic 142 executes a write command to update an original location of the next data block with updated data (step 606). In one embodiment, disk logic 142 perform a rewrite operation by writing the next data block that is cached to an original location of the next data block.

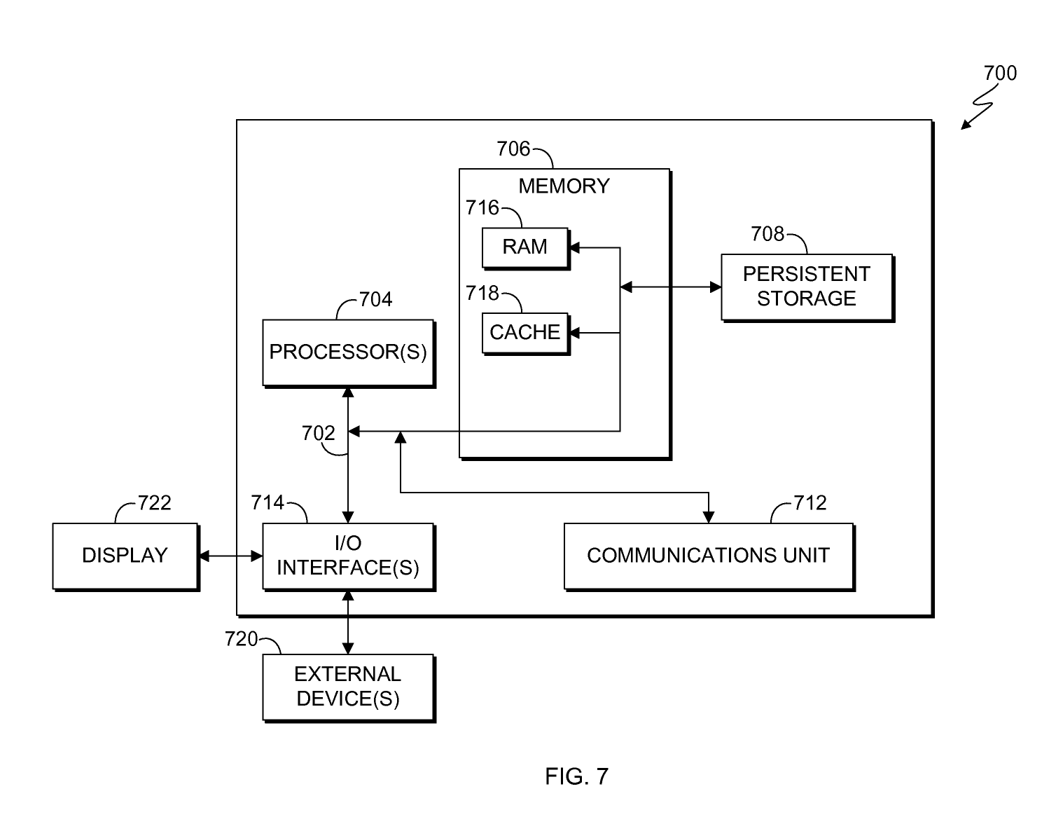

FIG. 7 is a block diagram of internal and external components of a computer system 700, which is representative the computer systems of FIG. 1, in accordance with an embodiment of the present invention. It should be appreciated that FIG. 7 provides only an illustration of one implementation and does not imply any limitations with regard to the environments in which different embodiments may be implemented. In general, the components illustrated in FIG. 7 are representative of any electronic device capable of executing machine-readable program instructions. Examples of computer systems, environments, and/or configurations that may be represented by the components illustrated in FIG. 7 include, but are not limited to, personal computer systems, server computer systems, thin clients, thick clients, laptop computer systems, tablet computer systems, cellular telephones (e.g., smart phones), multiprocessor systems, microprocessor-based systems, network PCs, minicomputer systems, mainframe computer systems, and distributed cloud computing environments that include any of the above systems or devices.

Computer system 700 includes communications fabric 702, which provides for communications between one or more processors 704, memory 706, persistent storage 708, communications unit 712, and one or more input/output (I/O) interfaces 714. Communications fabric 702 can be implemented with any architecture designed for passing data and/or control information between processors (such as microprocessors, communications and network processors, etc.), system memory, peripheral devices, and any other hardware components within a system. For example, communications fabric 702 can be implemented with one or more buses.

Memory 706 and persistent storage 708 are computer-readable storage media. In this embodiment, memory 706 includes random access memory (RAM) 716 and cache memory 718. In general, memory 706 can include any suitable volatile or non-volatile computer-readable storage media. Software is stored in persistent storage 708 for execution and/or access by one or more of the respective processors 704 via one or more memories of memory 706.

Persistent storage 708 may include, for example, a plurality of magnetic hard disk drives. Alternatively, or in addition to magnetic hard disk drives, persistent storage 708 can include one or more solid state hard drives, semiconductor storage devices, read-only memories (ROM), erasable programmable read-only memories (EPROM), flash memories, or any other computer-readable storage media that is capable of storing program instructions or digital information.

The media used by persistent storage 708 can also be removable. For example, a removable hard drive can be used for persistent storage 708. Other examples include optical and magnetic disks, thumb drives, and smart cards that are inserted into a drive for transfer onto another computer-readable storage medium that is also part of persistent storage 708.

Communications unit 712 provides for communications with other computer systems or devices via a network. In this exemplary embodiment, communications unit 712 includes network adapters or interfaces such as a TCP/IP adapter cards, wireless Wi-Fi interface cards, or 3G or 4G wireless interface cards or other wired or wireless communication links. The network can comprise, for example, copper wires, optical fibers, wireless transmission, routers, firewalls, switches, gateway computers and/or edge servers. Software and data used to practice embodiments of the present invention can be downloaded to computer system 700 through communications unit 712 (e.g., via the Internet, a local area network or other wide area network). From communications unit 712, the software and data can be loaded onto persistent storage 708.

One or more I/O interfaces 714 allow for input and output of data with other devices that may be connected to computer system 700. For example, I/O interface 714 can provide a connection to one or more external devices 720 such as a keyboard, computer mouse, touch screen, virtual keyboard, touch pad, pointing device, or other human interface devices. External devices 720 can also include portable computer-readable storage media such as, for example, thumb drives, portable optical or magnetic disks, and memory cards. I/O interface 714 also connects to display 722.

Display 722 provides a mechanism to display data to a user and can be, for example, a computer monitor. Display 722 can also be an incorporated display and may function as a touch screen, such as a built-in display of a tablet computer.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although preferred embodiments have been depicted and described in detail herein, it will be apparent to those skilled in the relevant art that various modifications, additions, substitutions and the like can be made without departing from the spirit of the invention, and these are, therefore, considered to be within the scope of the invention, as defined in the following claims.

What is claimed is:

1. A method comprising:
receiving, by one or more computer processors, a plurality of logically sequential data blocks of a file to write to a shingled magnetic disk;
writing the first data block of the plurality of logically sequential data blocks to a first physical data block of a data track, wherein the first physical data block is part of a sub-band of radially adjacent physical data blocks in a shingled direction; and
writing the remaining data blocks of the plurality of logically sequential data blocks to radially adjacent physical data blocks in the sub-band in the shingled direction, beginning with a physical data block radially adjacent to the first physical data block.

2. The method of claim 1, further comprising:
receiving, by the one or more computer processors, updated data to update data in one physical data block of the file;
caching data in physical data blocks of the sub-band in the shingled direction from the one physical data block of the file;
writing the updated data to the one physical data block of the file; and
rewriting the cached data to the corresponding physical data blocks of the sub-band in the shingled direction from the one physical data block of the file.

3. The method of claim 2, further comprising:
receiving, by the one or more computer processors, updated data to update data in more than one physical data blocks of the file;
caching data in physical data blocks of the sub-band in the shingled direction from a last physical data block of the more than one physical data blocks of the file requiring an update;
writing the updated data to the more than one physical data blocks of the file; and
rewriting the cached data to the corresponding physical data blocks of the sub-band in the shingled direction from the last physical data block of the more than one physical data blocks of the file requiring an update.

4. The method of claim 1, wherein writing the remaining data blocks of the plurality of logically sequential data blocks to radially adjacent physical data blocks in the sub-band in the shingled direction, beginning with a physical data block radially adjacent to the first physical data block comprises:
writing the remaining data blocks of the plurality of logically sequential data blocks to radially adjacent physical data blocks in the sub-band in the shingled direction, beginning with a physical data block radially adjacent to the first physical data block, until a data block gap is radially adjacent in the shingled direction to one physical data block of the physical data blocks in the sub-band.

5. The method of claim 3, further comprising:
caching data in physical data blocks of the sub-band in the shingled direction from a last physical data block of the more than one physical data blocks of the file requiring an update, until a data block gap is radially adjacent in the shingled direction to one physical data block in the sub-band.

6. The method of claim 4, wherein a data block gap includes one of: an inter-band gap or a physical data block of a deleted file.

7. The method of claim 1, wherein data tracks are organized in data bands that are separated by an inter-band gap, and wherein radially adjacent physical data blocks in a shingled direction within a same band are organized in a sub-band.

8. A computer program product comprising:
one or more computer readable storage media and program instructions stored on the one or more computer readable storage media, the program instructions comprising:
program instructions to receive a plurality of logically sequential data blocks of a file to write to a shingled magnetic disk;
program instructions to write the first data block of the plurality of logically sequential data blocks to a first physical data block of a data track, wherein the first physical data block is part of a sub-band of radially adjacent physical data blocks in a shingled direction; and
program instructions to write the remaining data blocks of the plurality of logically sequential data blocks to radially adjacent physical data blocks in the sub-band in the shingled direction, beginning with a physical data block radially adjacent to the first physical data block.

9. The computer program product of claim 8, wherein the program instructions stored on the one or more computer readable storage media further comprise:
program instructions to receive updated data to update data in one physical data block of the file;
program instructions to cache data in physical data blocks of the sub-band in the shingled direction from the one physical data block of the file;
program instructions to write the updated data to the one physical data block of the file; and
program instructions to rewrite the cached data to the corresponding physical data blocks of the sub-band in the shingled direction from the one physical data block of the file.

10. The computer program product of claim 9, wherein the program instructions stored on the one or more computer readable storage media further comprise:
program instructions to receive updated data to update data in more than one physical data blocks of the file;
program instructions to cache data in physical data blocks of the sub-band in the shingled direction from a last physical data block of the more than one physical data blocks of the file requiring an update;
program instructions to write the updated data to the more than one physical data blocks of the file; and
program instructions to rewrite the cached data to the corresponding physical data blocks of the sub-band in the shingled direction from the last physical data block of the more than one physical data blocks of the file requiring an update.

11. The computer program product of claim 8, wherein the program instructions to write the remaining data blocks of the plurality of logically sequential data blocks to radially adjacent physical data blocks in the sub-band in the shingled direction, beginning with a physical data block radially adjacent to the first physical data block comprises:
program instructions to write the remaining data blocks of the plurality of logically sequential data blocks to radially adjacent physical data blocks in the sub-band in the shingled direction, beginning with a physical data block radially adjacent to the first physical data block, until a data block gap is radially adjacent in the shingled direction to one physical data block of the physical data blocks in the sub-band.

12. The computer program product of claim 10, wherein the program instructions stored on the one or more computer readable storage media further comprise:
program instructions to cache data in physical data blocks of the sub-band in the shingled direction from a last physical data block of the more than one physical data blocks of the file requiring an update, until a data block gap is radially adjacent in the shingled direction to one physical data block in the sub-band.

13. The computer program product of claim 11, wherein a data block gap includes one of: an inter-band gap or a physical data block of a deleted file.

14. The computer program product of claim 8, wherein data tracks are organized in data bands that are separated by an inter-band gap, and wherein radially adjacent physical data blocks in a shingled direction within a same band are organized in a sub-band.

15. A computer system comprising:
one or more computer processors;
one or more computer readable storage media;
program instructions stored on the one or more computer readable storage media for execution by at least one of the one or more processors, the program instructions comprising:
program instructions to receive a plurality of logically sequential data blocks of a file to write to a shingled magnetic disk;
program instructions to write the first data block of the plurality of logically sequential data blocks to a first physical data block of a data track, wherein the first physical data block is part of a sub-band of radially adjacent physical data blocks in a shingled direction; and
program instructions to write the remaining data blocks of the plurality of logically sequential data blocks to radially adjacent physical data blocks in the sub-band in the shingled direction, beginning with a physical data block radially adjacent to the first physical data block.

16. The computer system of claim 15, wherein the program instructions stored on the one or more computer readable storage media further comprise:
program instructions to receive updated data to update data in one physical data block of the file;
program instructions to cache data in physical data blocks of the sub-band in the shingled direction from the one physical data block of the file;
program instructions to write the updated data to the one physical data block of the file; and
program instructions to rewrite the cached data to the corresponding physical data blocks of the sub-band in the shingled direction from the one physical data block of the file.

17. The computer system of claim 16, wherein the program instructions stored on the one or more computer readable storage media further comprise:
program instructions to receive updated data to update data in more than one physical data blocks of the file;
program instructions to cache data in physical data blocks of the sub-band in the shingled direction from a last physical data block of the more than one physical data blocks of the file requiring an update;
program instructions to write the updated data to the more than one physical data blocks of the file; and
program instructions to rewrite the cached data to the corresponding physical data blocks of the sub-band in the shingled direction from the last physical data block of the more than one physical data blocks of the file requiring an update.

18. The computer system of claim 15, wherein the program instructions to write the remaining data blocks of the plurality of logically sequential data blocks to radially adjacent physical data blocks in the sub-band in the shingled direction, beginning with a physical data block radially adjacent to the first physical data block comprises:
program instructions to write the remaining data blocks of the plurality of logically sequential data blocks to radially adjacent physical data blocks in the sub-band in the shingled direction, beginning with a physical data block radially adjacent to the first physical data block, until a data block gap is radially adjacent in the shingled direction to one physical data block of the physical data blocks in the sub-band.

19. The computer system of claim 17, wherein the program instructions stored on the one or more computer readable storage media further comprise:
program instructions to cache data in physical data blocks of the sub-band in the shingled direction from a last physical data block of the more than one physical data blocks of the file requiring an update, until a data block gap is radially adjacent in the shingled direction to one physical data block in the sub-band.

20. The computer system of claim 18, wherein a data block gap includes one of: an inter-band gap or a physical data block of a deleted file.
